(19) United States
(12) Patent Application Publication
(10) Pub. No.: US 2025/0299199 A1
(43) Pub. Date: Sep. 25, 2025

(54) VIRTUAL REALITY HEADSET AND ARTIFICIAL INTELLIGENCE VIRTUAL ASSISTANT INTEGRATION FOR ADDRESSING INQUIRIES FROM HEARING IMPAIRED CUSTOMERS

(71) Applicant: Bank of America Corporation, Charlotte, NC (US)

(72) Inventors: Brian Smith, Jacksonville, FL (US); Jonathan Coffey, Jacksonville, FL (US)

(21) Appl. No.: 18/613,235

(22) Filed: Mar. 22, 2024

(51) Int. Cl. G06Q 30/015; G02B 27/01; G06V 40/20; G10L 15/26

(52) U.S. Cl. CPC G06Q 30/015; G02B 27/017; G06V 40/28; G10L 15/26

(57) ABSTRACT

A method for improving service to hearing impaired customers at a brick-and-mortar location of an organization. The customer may use a virtual reality (“VR”) headset to translate a request for assistance from sign language into text. The VR headset may transmit the text of the request to an artificial intelligence (“AI”) virtual assistant. An application programming interface (“API”) may integrate the AI virtual assistant with the VR headset. The AI virtual assistant may confirm its understanding of the request with the customer, determine a team in the organization that can assist the customer, and transfer the customer to an agent in the team that does not know sign language. The API may integrate the AI virtual assistant with the VR headset to conduct real-time communication between the customer who is communicating with sign language and the agent who is communicating with speech or text to resolve the request.

### FIELD OF TECHNOLOGY

Aspects of the disclosure relate to servicing a customer who is hearing impaired.

### BACKGROUND OF THE DISCLOSURE

Approximately 15 percent of American adults report trouble hearing. Hearing conditions may include deafness, being hard of hearing, experiencing ringing in the ears, or having sensitivity to noise. More than a half-million people throughout the United States of America (“USA”) use American Sign Language (“ASL”) to communicate as their native language. ASL is the third most used language in the United States, after English and Spanish. ASL is the most used sign language by hearing impaired people in the USA.

When a hearing impaired customer enters a commercial location of an organization such as a financial center of a bank, the customer may find limited resources for obtaining service and answering questions. The location may staff someone who knows sign language. The organization may equip the location with video remote interpreting service using equipment such as a videophone, computer, laptop, tablet, or smartphone.

If the location does not have a sign language interpreter on-staff and present at that time, or does not have remote interpreting services, the customer may need to communicate with staff using handwritten notes.

Even in the less common situation where a location has a staff member who speaks sign language, the staff member may be out of the office when the customer comes to the location. These situations may leave a customer dissatisfied because the customer's concerns were not fully and efficiently addressed. There is a need to bridge the communication barrier of the hearing impaired customer with the capabilities of a typical commercial location.

### SUMMARY OF THE DISCLOSURE

The need to bridge a communication barrier between a hearing impaired customer and an organization may be addressed by the organization using a VR headset integrated with an AI virtual assistant using an API to address a request of a hearing impaired customer. Overcoming the communication barrier between a hearing impaired customer and an organization may result in the former having a similar level of experience and satisfaction as a normal hearing person would experience in addressing a request to the organization. Using an API to integrate a VR headset with an AI virtual assistant may result in assisting a hearing impaired customer such that the organization does not need to turn away the hearing impaired customer due to lack of support.

The request may be made using sign language and may be handled in real-time with an agent at the organization. The apparatus and method may contribute to an accurate and efficient communication between the hearing impaired customer and the organization. The apparatus and method may provide respect to the hearing impaired customer by accurately addressing their concerns in real-time.

The method may improve service to a customer who is hearing impaired.

The method may include using a virtual reality (“VR”) headset to identify hand movements of the customer. The VR headset may identify the hand movements as sign language communicated by the customer. The customer may convey a request for assistance to an organization using sign language. The VR headset may translate the request for assistance from sign language into text. The customer may wear the VR headset at a brick-and-mortar location of an organization.

The method may include using the VR headset to transmit the text of the request to an artificial intelligence (“AI”) virtual assistant. An application programming interface (“API”) may integrate the AI virtual assistant with the VR headset. This integration may facilitate an exchange between the VR headset and the AI virtual assistant.

The VR headset and AI virtual assistant integration may be configured to address the request for assistance from the customer. The customer may be hearing impaired and may make the request using sign language. The customer may wear a VR headset. The VR headset may contain cameras that detect hand movements of the customer.

The customer may make the request in a brick-and-mortar location of the enterprise. The organization may provide the VR headset to the customer. The customer may use their own VR headset at the brick-and-mortar location.

The method may include the customer making the request for assistance at a location remote from the brick-and-mortar location of the enterprise. The customer may use their own VR headset at a remote location. The customer may use a VR headset supplied by the enterprise at a remote location.

The method may include the VR headset translating a request for assistance from sign language into text. The VR headset may detect hand movements made by the customer. The VR headset may contain trained artificial intelligence and/or machine learning algorithms to identify the hand movements as sign language and to translate the sign language into text. The VR headset may store the text in a storage location on the VR headset. The VR headset may store the text in a remote storage location.

The method may include the AI virtual assistant translating a request for assistance from sign language into text. The AI virtual assistant may contain trained artificial intelligence and/or machine learning algorithms to identify the hand movements as sign language and to translate the sign language into text. The API may transfer to the AI virtual assistant an electronic record of the hand movements detected by the VR headset. The API may transfer the electronic record of the hand movements in real-time. The API may transfer the electronic record in batches. The AI virtual assistant may store the text in a storage location on the VR headset. The AI virtual assistant may store the text in a remote storage location.

An API may be a standard of integration to provide one-way or two-way communication of data and information between the VR headset and AI virtual assistant.

The API used to integrate the VR headset and the AI virtual assistant may be Simple Object Access Protocol APIs (“SOAP APIs”), Websocket APIs (“Websocket APIs”), Remote Procedure Calls APIs (“RPC APIs”), or Representational State Transfer APIs (REST APIs”).

The selected API may be a private API. The selected API may be a public API.

The API may include endpoints. An API endpoint may be one end of a communication channel. An endpoint may be a touchpoint within the API that accepts requests from and sends back responses to another system. An API endpoint may be a way for the API to facilitate different systems and applications to communicate with each other. These different systems and applications may send and receive information and instructions via an API endpoint.

An endpoint may be a location from which APIs can access the resources they need to carry out their function. An API endpoint may be associated with a Uniform Resource Locator (URL). An API server may host API endpoints such that the API server may accept and process calls directed to the URLs of the endpoints.

The interface location between the API and the VR headset may be at an API endpoint. The API endpoint may accept a request from the VR headset. The API endpoint may send back a response to the VR headset.

The interface location between the API and the AI virtual assistant may be an API endpoint. The API endpoint may accept a request from the AI virtual assistant. The API endpoint may send back a response to the AI virtual assistant.

The endpoint in the API may accept a request from the VR headset and send back a response to the AI virtual assistant. The endpoint in the API may accept a request from the AI virtual assistant and send back a response to the VR headset. The endpoint of the API may be located within the VR headset. The endpoint of the API may be located remotely from the VR headset.

The API may be secured with authorization tokens. The API may be secured with API keys.

The method may include using the AI virtual assistant to confirm with the customer that the AI virtual assistant correctly understands the request.

The method may include using the AI virtual assistant to determine a team in the organization that can assist the customer. The team may be a team in a contact center. The team may be a team in a call center. The team may be a team in a department of the organization.

The team may include a customer service team, a mortgage team, a credit card team, a debit card team, a cybersecurity team, an investment team, a banking account team, a fraud team, a refund team, an identify preservation team, a credit score team, and combinations of these teams.

The method may include using the AI virtual assistant to transfer the customer to an agent in the team. The agent may be in a financial center. The agent may be in a store. The agent may be in a contact center. The agent may be in a call center.

The method may include using the AI virtual assistant integrated with the VR headset to conduct real-time communication between the agent and the customer to resolve the request.

The sign language may be American Sign Language (“ASL”).

The brick-and-mortar location may be a financial center. The AI virtual assistant may be a virtual financial assistant (“VFA”).

The VR headset may include VR, augmented reality (“AR”), extended reality (“XR”), spatial computing, and a combination herein.

The method of providing the improved service to the customer may lead to an improved level of customer satisfaction.

The real-time communication between the agent and the customer may include the VR headset worn by the customer identifying hand movements of the customer. The VR headset may identify the hand movements as sign language. The VR headset may translate the customer's sign language into text. The VR headset may be integrated with an API to send the AI virtual assistant the text. The VR headset may transmit the communication to the agent as text. The AI virtual assistant may transmit the communication to the agent as speech. The VR headset may transmit the communication to the agent as text. The VR headset may transmit the communication to the agent as speech.

The AI virtual assistant may transmit text typed by the agent to the VR headset worn by the customer. The VR headset may present the communication as text. The VR headset may present the communication as sign language. The AI virtual assistant may be integrated into the VR headset to present the communication as sign language. The VR headset may present sign language with cartoon-like characters. The VR headset may present sign language with realistic characters.

The real-time communication between the agent and the customer may involve the VR headset worn by the customer. The VR headset may translate the customer's sign language into text. The customer may wear the VR headset. The AI virtual assistant may transmit the text. The AI virtual assistant may transmit the text and present it to the agent as speech. The VR headset may transmit the information to the agent as text. The VR headset may transmit the information to the agent as speech. The AI virtual assistant may generate the speech.

The agent may type text that the AI virtual assistant transmits to the VR headset worn by the customer. The VR headset may present the communication to the customer as text. The VR headset may translate and present the text as sign language. The VR headset may generate sign language. The VR headset may present the sign language as cartoon characters. The VR headset may present sign language with realistic characters.

The agent may use speech to reply to the customer. The agent may wear a VR headset that translates the speech into text. The agent may speak to the AI virtual assistant that translates the speech into text. The AI virtual assistant may transmit the text to the VR headset worn by the customer. The VR headset may present the communication to the customer as text. The VR headset may translate the communication and present it to the customer as sign language. The VR headset may generate sign language.

The agent may communicate in real-time with the customer despite the agent not knowing sign language.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative block diagram in accordance with principles of the disclosure;

FIG. 2 shows an illustrative block diagram in accordance with principles of the disclosure;

FIG. 3 shows an illustrative block diagram in accordance with principles of the disclosure; and

FIG. 4 shows an illustrative flowchart in accordance with principles of the disclosure.

### DETAILED DESCRIPTION OF THE DISCLOSURE

Provided are apparatus and methods for improving service to a customer who is hearing impaired. The apparatus may implement the methods.

The apparatus may include a system for improving service to the customer who is hearing impaired. For the purposes of this application, the term “hearing impaired” should be understood to include a variety of hearing conditions such as deafness, being hard of hearing, experiencing ringing in the ears, and having high sensitivity to noise.

The system may improve service to a customer who is hearing impaired.

The system may include using a virtual reality (“VR”) headset. The VR headset may provide a virtual reality environment for the wearer. The VR headset may be a head-mounted device.

The system may include an artificial intelligence (“AI”) virtual assistant. Application programming interface (“API”) may integrate the AI virtual assistant with the VR headset.

The API-integrated VR headset and AI virtual assistant may be configured to address a request for assistance from a customer to an enterprise. The customer may be hearing impaired and may make the request using sign language. The customer may wear a VR headset. The VR headset may contain cameras that detect hand movements of the customer. The VR headset may recognize the hand movements as sign language. The VR headset may translate the sign language into text.

The customer may make the request in a brick-and-mortar location of the enterprise. The organization may provide the VR headset to the customer. The customer may use their own VR headset at the brick-and-mortar location.

The customer may make the request at a location remote from a brick-and-mortar location of the enterprise. The customer may use their own VR headset at their location. The customer may use a VR headset supplied by the enterprise.

The VR headset may be configured to translate a request for assistance from sign language into text. The VR headset may contain trained artificial intelligence and/or machine learning algorithms to identify the hand movements as sign language. The VR headset may translate sign language into text. The VR headset may store the text in a storage location on the VR headset. The VR headset may store the text in a remote storage location.

The AI virtual assistant may be configured to translate a request for assistance from sign language into text. The API may transfer an electronic record of the hand movements detected by the VR headset. The API may transfer the electronic record of the hand movements in real-time. The API may transfer the electronic record in batches. The AI virtual assistant may contain trained artificial intelligence and/or machine learning algorithms to identify the hand movements as sign language. The AI virtual assistant may translate sign language into text. The AI virtual assistant may store the text in a storage location on the VR headset. The AI virtual assistant may store the text in a remote storage location.

The API may integrate the AI virtual assistant with the VR headset. API may be a standard of integration to provide one-way or two-way communication of data and information between the VR headset and AI virtual assistant.

The API used may include one or more of the following types of APIs.

The API may use the Simple Object Access Protocol (“SOAP APIs”). SOAP APIs may be found commonly in previous generations of API usage. A party and the enterprise may exchange messages using XML.

The API may use the Websocket (“Websocket APIs”). Websocket APIs may use JSON objects to pass data. Websocket APIs may facilitate two-way communication between a party and the enterprise. Websocket APIs may provide callbacks that may allow for working with multiple threads. The callbacks that may facilitate working on something asynchronously. Websocket APIs may be more efficient than other APIs in sending callback messages.

The API may use the Remote Procedure Calls (“RPC APIs”). RPC APIs may include obtaining input from a party. The input may be communicated electronically back to the enterprise.

The API may use Representational State Transfer (REST APIs”). REST APIs may be stateless. The REST APIs may include in each inquiry for output data from a server all the information necessary for processing the inquiry. REST APIs may obtain output data addressing the inquiry without requiring any data to be stored on the server.

The API used to integrate the VR headset and the AI virtual assistant may include a SOAP API, a Websocket API, an RPC API, a REST API, and combinations herein.

The selected API may be a private API. The private API may be internal to the enterprise. The private API may connect an enterprise provided VR headset to the AI virtual assistant.

The selected API may be a public API. The public API may be open to the public. The public API may contain gating that only allows qualified parties to use the API. When a customer comes into the brick-and-mortar location of the enterprise with the customer's own VR headset, the VR headset may be integrated with the AI virtual assistant with a public API. The public API may be secured to only allow access with a key or other cybersecurity measure.

When a customer comes to access the enterprise remotely and uses the customer's own VR headset, the VR headset may be integrated with the AI virtual assistant with a public API. The public API may be secured to only allow access with a key or other cybersecurity measure.

The API may include endpoints. An API endpoint may be one end of a communication channel. An endpoint may be a touchpoint within the API that accepts requests from and sends back responses to another system. An API endpoint may be a way for the API to facilitate different systems and applications to communicate with each other. These different systems and applications may send and receive information and instructions via an API endpoint.

An endpoint may be a location from which APIs can access the resources they need to carry out their function. An API endpoint may be associated with a Uniform Resource Locator (URL). An API server may host API endpoints such that the API server may accept and process calls directed to the URLs of the endpoints.

The interface location between the API and the VR headset may be at an API endpoint. The API endpoint may accept a request from the VR headset. The API endpoint may send back a response to the VR headset.

The interface location between the API and the AI virtual assistant may be an API endpoint. The API endpoint may accept a request from the AI virtual assistant. The API endpoint may send back a response to the AI virtual assistant.

The endpoint in the API may accept a request from the VR headset and send back a response to the AI virtual assistant. The endpoint in the API may accept a request from the AI virtual assistant and send back a response to the VR headset. The endpoint of the API may be located within the VR headset. The endpoint of the API may be located remotely from the VR headset.

The VR headset may be located at a brick-and-mortal location of the enterprise. The VR headset may be supplied to the customer by the enterprise. The VR headset may be the customer's own VR headset brought by the customer to the brick-and-mortal location. The VR headset may be the customer's and located at a customer's remote location.

The interface may take place in the VR headset. The interface may take place remotely from the VR headset.

The API may be secured with authorization tokens. Authorization tokens may be used to validate the identity of the customer. The authorization may include the customer logging into their account that they have with the enterprise.

The API may be secured with API keys. API keys may facilitate the API to verify the VR headset and the AI virtual assistant to confirm they are what they report to be.

The request for assistance may relate to an account the customer has with the organization. The request may include a financial matter. The request may include an inquiry about the customer's mortgage. The request may include an inquiry about the customer's credit and debit cards. The request may include an inquiry about the customer's credit score. The request may include an inquiry about automated bill paying. The request may include an inquiry about the customer's savings and checking account. The request may include an inquiry about wealth management. The request may include an inquiry about insurance.

The AI virtual assistant may confirm with the customer that the AI virtual assistant correctly understands the request.

The AI virtual assistant may be configured to determine a team in the organization that can assist the customer. The team may be a team in a contact center. The team may be a team in a call center.

The team may include a customer service team, a mortgage team, a credit card team, a debit card team, a cybersecurity team, an investment team, a banking account team, a fraud team, a refund team, an identify preservation team, a credit score team, and combinations of these teams.

The AI virtual assistant may be configured to transfer the customer to an agent in the team. The agent may be in a financial center. The agent may be in a store. The agent may be in a contact center. The agent may be in a call center.

The agent may be a member of a team. The agent may include a customer service agent, a mortgage agent, a credit card agent, a debit card agent, a cybersecurity agent, an investment agent, a banking account agent, a fraud agent, a refund agent, an identify preservation agent, and a credit score agent.

The AI virtual assistant and the VR headset, integrated with each other using the API, are configured to conduct real-time communication between the agent and the customer to resolve the request.

The sign language may be American Sign Language (“ASL”). The sign language may be Chinese Sign Language (“CSL” or “ZGS”). The sign language may be British Sign Language (“BSL”). The sign language may be Australian Sign Language (“Ausian”). The sign language may be New Zealand Sign Language (“NZSL”). The sign language may be Japanese Sign Language (“JSL”). The sign language may be Brazilian Sign Language (“Libras”, “LSB”, “LGB”, or “LSCB”). The sign language may be Indo-Pakistani Sign Language (“IPSL”). The sign language may be French Sign Language (“LSF”). The sign language may be Mexican Sign Language (“LSM”).

The brick-and-mortar location may be a financial center. The AI virtual assistant may be a virtual financial assistant (“VFA”).

The VR headset may include VR, augmented reality (“AR”), extended reality (“XR”), spatial computing, and a combination herein.

The system for providing improved service to the hearing-impaired customer may lead to an improved level of customer satisfaction.

The real-time communication between the agent and the customer may include the VR headset worn by the customer. The VR headset may translate the customer's sign language into text. The customer may wear the VR headset. The AI virtual assistant may transmit the text. The AI virtual assistant may transmit the text and present it to the agent as speech. The VR headset may transmit the information to the agent as text. The VR headset may transmit the information to the agent as speech. The AI virtual assistant may generate the speech from text provided by the API from the VR headset.

The agent may type text that the AI virtual assistant transmits to the VR headset worn by the customer. The VR headset may present the communication to the customer as text. The VR headset may translate the text and present it as sign language. The VR headset may generate sign language. The VR headset may present the sign language as cartoon characters. The VR headset may present sign language with realistic characters.

The agent may use speech to reply to the customer. The agent may wear a VR headset that translates the speech into text. The agent's VR headset may be integrated with the AI virtual assistant with an API. The API may be used to integrate both the agent's VR headset and the customer's VR headset with the AI virtual assistant. A separate API may be used to integrate the agent's VR headset with the AI virtual assistant and the customer's VR headset with the AI virtual assistant.

The AI virtual assistant may translate the speech into text. The AI virtual assistant may transmit the text to the VR headset worn by the customer. The VR headset may present the communication to the customer as text. The VR headset may translate the communication and present it to the customer as sign language. The VR headset may generate sign language. The VR headset may present sign language with cartoon-like characters. The VR headset may present sign language with realistic characters.

The agent may communicate in real-time with the customer despite the agent not knowing sign language.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional, and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

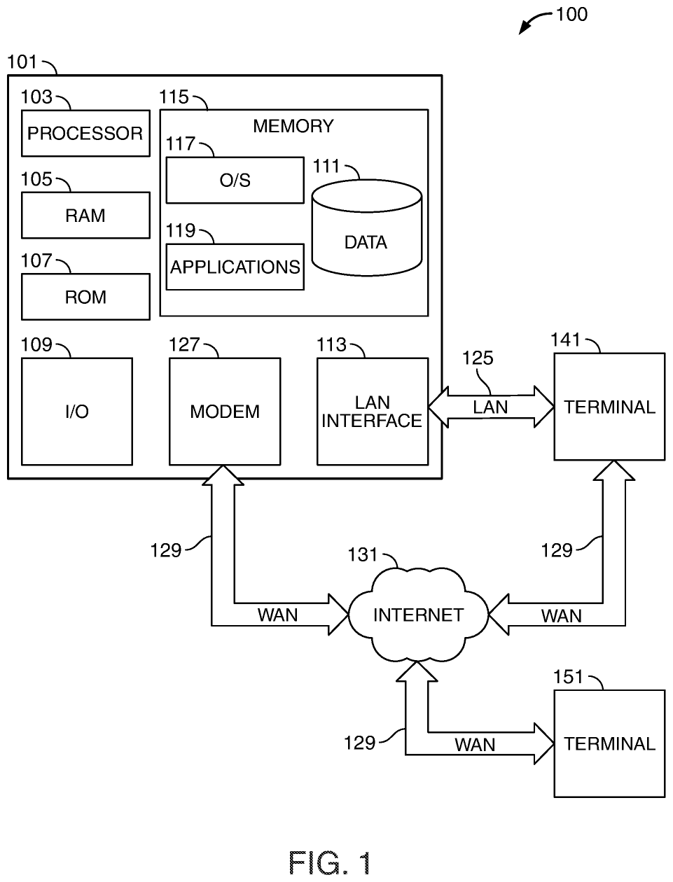

FIG. 1 shows an illustrative block diagram of system 100 that includes computer 101. Computer 101 may alternatively be referred to herein as an “engine,” “server” or a “computing device.” Computer 101 may be a workstation, desktop, laptop, tablet, smartphone, or any other suitable computing device. Elements of system 100, including computer 101, may be used to implement various aspects of the systems and methods disclosed herein. Each of the systems, methods and algorithms illustrated below may include some or all the elements and apparatus of system 100.

Computer 101 may have a processor 103, including a central processing unit (“CPU”), for controlling the operation of the device and its associated components, and may include RAM 105, ROM 107, input/output (“I/O”) 109, and a non-transitory or non-volatile memory 115. Machine-readable memory may be configured to store information in machine-readable data structures. Processor 103 may also execute all software running on the computer. Other components, such as graphics processing unit (“GPU”), EEPROM, Flash memory, neural-network processing elements, or any other suitable components, may also be part of the computer 101.

Memory 115 may be comprised of any suitable permanent storage technology—e.g., a hard drive. Memory 115 may store software including the operating system 117 and application program(s) 119 along with any data 111 needed for the operation of the system 100. Memory 115 may also store videos, text, and/or audio assistance files. The data stored in memory 115 may also be stored in cache memory, or any other suitable memory.

I/O module 109 may include connectivity to a microphone, keyboard, touch screen, mouse, and/or stylus through which input may be provided into computer 101. The input may include input relating to cursor movement. The input/output module may also include one or more speakers for providing audio output and a video display device for providing textual, audio, audiovisual, and/or graphical output. The input and output may be related to computer application functionality.

System 100 may be connected to other systems via a local area network interface 113. System 100 may operate in a networked environment supporting connections to one or more remote computers, such as terminals 141 and 151. Terminals 141 and 151 may be personal computers or servers that include many or all the elements described above relative to system 100. The network connections depicted in FIG. 1 include a local area network (“LAN”) 125 and a wide area network (“WAN”) 129 but may also include other networks. When used in a LAN networking environment, computer 101 is connected to LAN 125 through LAN interface 113 or an adapter. When used in a WAN networking environment, computer 101 may include a modem 127 or other means for establishing communications over WAN 129, such as Internet 131.

It will be appreciated that network connections shown are illustrative and other means of establishing a communications link between computers may be used. The existence of various well-known protocols such as TCP/IP, Ethernet, FTP, HTTP, and the like is presumed, and the system can be operated in a client-server configuration to permit retrieval of data from a web-based server or application programming interface (“API”). Web-based, for the purposes of this application, is to be understood to include a cloud-based system. The web-based server may transmit data to any other suitable computer system. The web-based server may also send computer-readable instructions, together with the data, to any suitable computer system. The computer-readable instructions may include instructions to store the data in cache memory, the hard drive, secondary memory, or any other suitable memory.

Additionally, application program(s) 119, which may be used by computer 101, may include computer executable instructions for invoking functionality related to communication, such as e-mail, Short Message Service (“SMS”), and voice input and speech recognition applications. Application program(s) 119 (which may be alternatively referred to herein as “plugins,” “applications,” or “apps”) may include computer executable instructions for invoking functionality related to performing various tasks. Application program(s) 119 may utilize one or more algorithms that process received executable instructions, perform power management routines or other suitable tasks.

Application program(s) 119 may include computer executable instructions (alternatively referred to as “programs”). The computer executable instructions may be embodied in hardware or firmware (not shown). Computer 101 may execute the instructions embodied by the application program(s) 119 to perform various functions.

Application program(s) 119 may utilize the computer-executable instructions executed by a processor. Programs may include routines, programs, objects, components, data structures, etc., that perform tasks or implement abstract data types. A computing system may be operational with distributed computing environments. Tasks may be performed by remote processing devices that are linked through a communications network. In a distributed computing environment, a program may be in both local and remote computer storage media including memory storage devices. Computing systems may rely on a network of remote servers hosted on the Internet to store, manage, and process data (e.g., “cloud computing” and/or “fog computing”).

Any information described above in connection with data 111, and any other suitable information, may be stored in memory 115.

The invention may be described in the context of computer-executable instructions, such as application(s) 119, being executed by a computer. Programs may include routines, programs, objects, components, data structures, etc., that perform tasks or implement data types. The invention may also be practiced in distributed computing environments. Tasks may be performed by remote processing devices that are linked through a communications network. In a distributed computing environment, programs may be in both local and remote computer storage media including memory storage devices. It should be noted that such programs may be considered for the purposes of this application as engines with respect to the performance of the tasks to which the programs are assigned.

Computer 101 and/or terminals 141 and 151 may also include various other components, such as a battery, speaker, and/or antennas (not shown). Components of computer system 101 may be linked by a system bus, wirelessly or by other suitable interconnections. Components of computer system 101 may be present on one or more circuit boards. In some embodiments, the components may be integrated into a single chip. The chip may be silicon-based.

Terminal 141 and/or terminal 151 may be portable devices such as a laptop, cell phone, tablet, smartphone, or any other computing system for receiving, storing, transmitting and/or displaying relevant information. Terminal 141 and/or terminal 151 may be one or more user devices. Terminals 141 and 151 may be identical to system 100 or different. Differences may be related to hardware components and/or software components.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, cloud-based systems, programmable consumer electronics, network PCs, minicomputers, mainframe computers, distributed computing environments that include any of the above systems or devices, and the like.

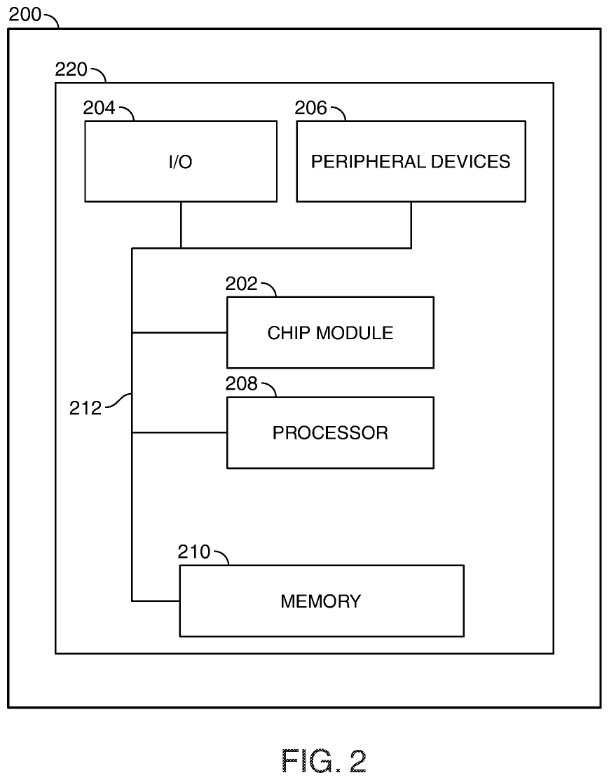

FIG. 2 shows illustrative apparatus 200 that may be configured in accordance with the principles of the disclosure. Apparatus 200 may be a computing device. Apparatus 200 may include one or more features of the apparatus shown in FIG. 2. Apparatus 200 may include chip module 202, that may include one or more integrated circuits, and that may include logic configured to perform any other suitable logical operations.

Apparatus 200 may include one or more of the following components: I/O circuitry 204, that may include a transmitter device and a receiver device and may interface with fiber optic cable, coaxial cable, telephone lines, wireless devices, PHY layer hardware, a keypad/display control device or any other suitable media or devices; peripheral devices 206, that may include counter timers, real-time timers, power-on reset generators or any other suitable peripheral devices; logical processing device 208, that may compute data structural information and structural parameters of the data; and machine-readable memory 210.

Machine-readable memory 210 may be configured to store in machine-readable data structures: machine executable instructions, (which may be alternatively referred to herein as “computer instructions” or “computer code”), applications such as applications 119 (shown in FIG. 1), signals, and/or any other suitable information or data structures.

A system bus or other interconnections 212 may couple components 202, 204, 206, 208 and 210 and may be present on one or more circuit boards such as circuit board 220. In some embodiments, a single chip may integrate the components. The chip may be silicon-based.

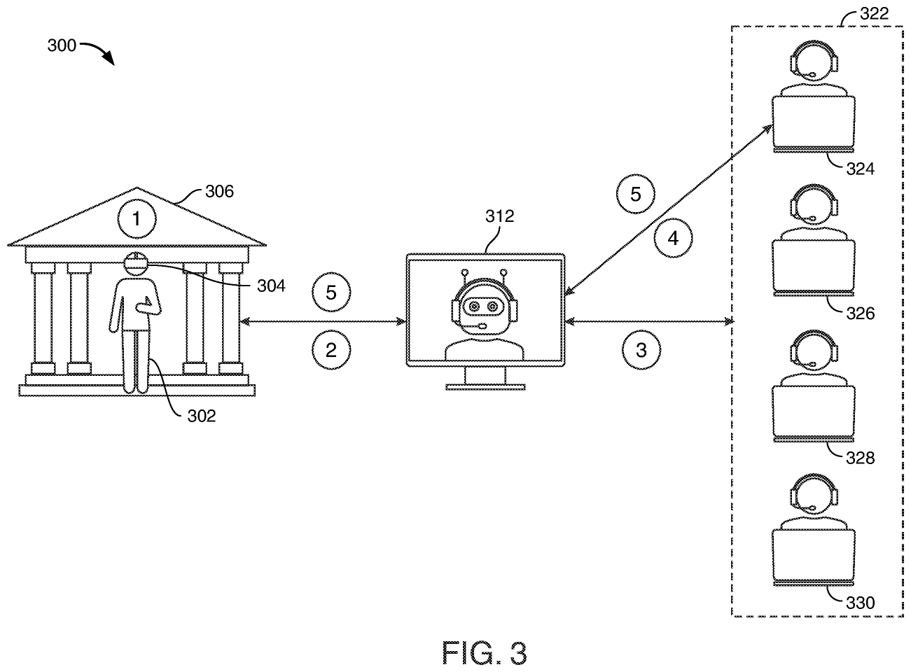

FIG. 3 shows illustrative block diagram 300. Illustrative block diagram 300 may show an apparatus that includes a system for improving service to the customer who is hearing impaired.

At step 1, customer 302 who is hearing impaired is shown as using the system. Customer 302 may wear a VR headset 304. Customer 302 may be located at brick-and-mortar location 306 of an organization. Customer 302 may be hearing impaired. Location 306 may be a financial center. VR headset 304 may be configured to identify hand movements of customer 302. The hand movements may be sign language. VR headset 304 may identify the hand movements as sign language. VR headset 304 may translate sign language into text.

At step 2, the VR headset 304 may be integrated with an API to AI virtual assistant 312. VR headset 304 may be configured to transmit the text to provide it to AI virtual assistant 312. AI virtual assistant 312 may be configured to confirm with customer 302 that the AI virtual assistant correctly understands the request.

At step 3, the AI virtual assistant 312 may be configured to determine that team 322 in the organization may assist the customer. When the enterprise is a financial center, teams may include mortgage services, inquiries relating to a savings account or a checking account of customer 302, a credit card or debit card of customer 302, automated bill payments, amount other possible areas AI virtual assistant 312 may provide assistance. Team 322 may include agent 324, agent 326, agent 328, and agent 330. Team 322 may be a team in a contact center. The agents may be agents in a contact center.

Team 322 may include a customer service team, a mortgage team, a credit card team, a debit card team, a cybersecurity team, an investment team, a banking account team, a fraud team, a refund team, an identify preservation team, a credit score team, and combinations of these teams.

Agent 324 may be a member of a team. The agent may include a customer service agent, a mortgage agent, a credit card agent, a debit card agent, a cybersecurity agent, an investment agent, a banking account agent, a fraud agent, a refund agent, an identify preservation agent, and a credit score agent.

At step 4, the AI virtual assistant may be configured to transfer the customer to agent 324 in team 322. Agent 324 may be randomly selected. Agent 324 may be the next agent who is available in a queue in team 322. Agent 324 may possess certain skills that make them most appropriate to address the needs of customer 302.

At step 5, AI virtual assistant 312 and VR headset 304 may be configured to conduct real-time communication between agent 324 and customer 302 to resolve the request. The API may integrate AI virtual assistant 312 and VR headset 304 with one another. This API integration may facilitate real-time communication between agent 324 and customer 302.

Real-time communication between agent 324 and customer 302 may include VR headset 304 worn by customer 302 translating sign language signed by customer 302 into text. AI virtual assistant 312 may transmit the text. AI virtual assistant 312 may transmit the text and present it to agent 324 as speech. VR headset 304 may transmit the information to agent 324 as text. VR headset 304 may transmit the information to agent 324 as speech. AI virtual assistant 312 may generate the speech from text provided by the API from VR headset 304.

Agent 324 may type text that AI virtual assistant 312 transmits to VR headset 304 worn by customer 302. VR headset 304 may present the communication to customer 302 as text. VR headset 304 may translate the text and present it as sign language. VR headset 304 may generate sign language. VR headset 304 may present sign language as cartoon characters. VR headset 304 may present sign language with realistic characters.

Agent 324 may use speech to reply to the customer. Agent 324 may wear a VR headset that translates the speech into text. VR headset of agent 324 may be integrated with AI virtual assistant 312 with an API. The API may be used to integrate the VR headset of agent 324 and VR headset 304 of customer 302 with AI virtual assistant 312. A separate API may be used to integrate the VR headset of agent 324 with AI virtual assistant 312 and VR headset 304 of customer 302 with AI virtual assistant 312.

AI virtual assistant 312 may translate the speech into text. AI virtual assistant 312 may transmit the text to VR headset 304 worn by customer 302. VR headset 304 may present the communication to customer 302 as text. VR headset 304 may translate the communication and present it to customer 302 as sign language. VR headset 304 may generate sign language. VR headset 304 may present sign language with cartoon-like characters. VR headset 304 may present sign language with realistic characters.

Agent 324 may communicate in real-time with customer 302 despite agent 324 not knowing sign language.

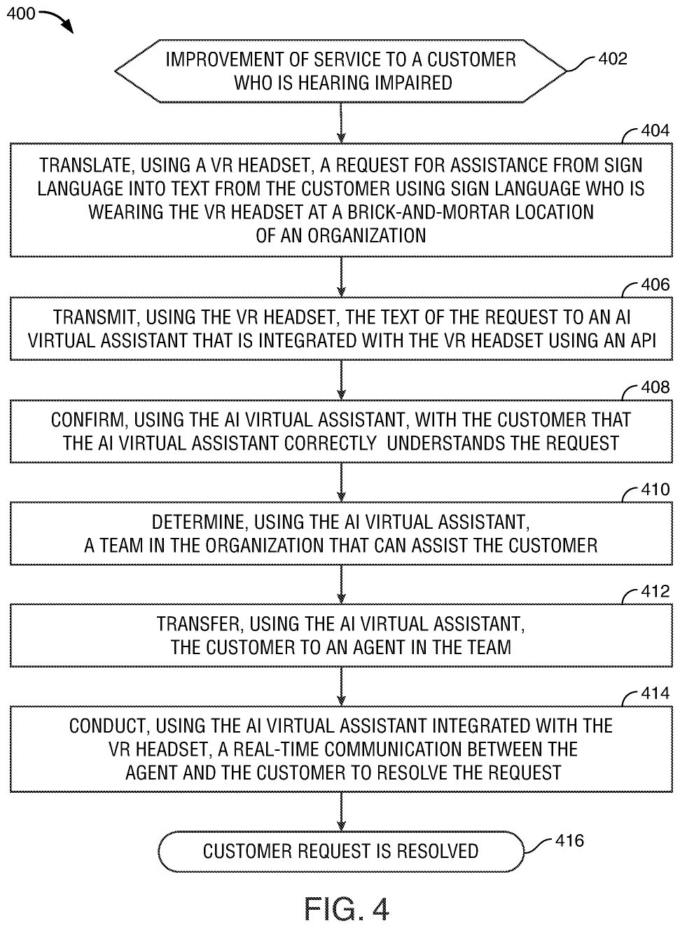

FIG. 4 shows illustrative flowchart 400, beginning at step 402, that may provide a process for improving service to the customer who is hearing impaired.

At step 404, the VR headset may identify the hand movements of the customer who is communicating a request for assistance. The VR headset may recognize the hand motions as sign language. The VR headset may translate the request for assistance into text. The customer may make the request using sign language. The customer may be wearing a VR headset. The VR headset may include a VR headset, an AR headset, a XR headset, a spatial computing headset, or may combine two or more of these technologies.

The customer may be situated in a brick-and-mortar location of an organization. The VR headset may translate sign language into text. The sign language may include ASL. The brick-and-mortar location may be a financial center. The brick-and-mortar location may be a store.

At step 406, the VR headset may transmit the text of the request to the AI virtual assistant. The API may integrate the AI virtual assistant with the VR headset. The AI virtual assistant may be a VFA.

At step 408, the AI virtual assistant may confirm with the customer that the AI virtual assistant correctly understands the request.

At step 410, the AI virtual assistant may determine a team in the organization that can assist the customer. The team may be best situated in the organization to assist the customer. The team may be a team in a contact center. The team may be a team in a call center.

The team may include a customer service team, a mortgage team, a credit card team, a debit card team, a cybersecurity team, an investment team, a banking account team, a fraud team, a refund team, an identify preservation team, a credit score team, and combinations of these teams.

At step 412, AI virtual assistant may transfer the customer to an agent in the team. The agent may be randomly assigned. The agent may be assigned based on the agent's expertise. The agent may be in a financial center. The agent may be in a store. The agent may be in a contact center. The agent may be in a call center.

The agent may be a member of a team. The agent may include a customer service agent, a mortgage agent, a credit card agent, a debit card agent, a cybersecurity agent, an investment agent, a banking account agent, a fraud agent, a refund agent, an identify preservation agent, and a credit score agent.

At step 414, the API may integrate the AI virtual assistant with the VR headset to facilitate real-time communication between the agent and the customer to resolve the request.

The real-time communication between the agent and the customer may involve the VR headset worn by the customer. The VR headset may translate the customer's sign language into text. The AI virtual assistant may transmit the text. The AI virtual assistant may transmit the text and present it to the agent as speech. The VR headset may transmit the information to the agent as text. The VR headset may transmit the information to the agent as speech. The AI virtual assistant may generate the speech.

The agent may type text that the AI virtual assistant transmits to the VR headset worn by the customer. The VR headset may present the communication to the customer as text. The VR headset may translate and present the text as sign language. The VR headset may generate sign language. The VR headset may present the sign language as cartoon characters. The VR headset may present sign language with realistic characters.

The agent may use speech to reply to the customer. The agent may wear a VR headset that translates the speech into text. The agent may speak to the AI virtual assistant that translates the speech into text. The AI virtual assistant may transmit the text to the VR headset worn by the customer. The VR headset may present the communication to the customer as text. The VR headset may translate the communication and present it to the customer as sign language. The VR headset may generate sign language.

At step 416, the agent may resolve the customer's request.

Thus, provided may be systems and methods relating to improving service to a customer who is hearing impaired. Persons skilled in the art will appreciate that the present invention can be practiced by other than the described embodiments, which are presented for purposes of illustration rather than of limitation. The present invention is limited only by the claims that follow.

What is claimed is:

1. A system for improved service to a customer who is hearing impaired, the system comprising:
a virtual reality (“VR”) headset; and
an artificial intelligence (“AI”) virtual assistant, said AI virtual assistant is integrated with the VR headset using an application programming interface (“API”);
wherein:
the VR headset is configured to:
translate a request for assistance from sign language into text, said request is made by the customer that is using sign language, and said customer is wearing the VR headset at a brick-and-mortar location of an organization; and
transmit the text of the request to the AI virtual assistant;
the AI virtual assistant is configured to:
confirm with the customer that the AI virtual assistant has a correct understanding of the request;
determine a team in the organization that can assist the customer; and
transfer the customer to an agent in the team; and
the AI virtual assistant and the VR headset, integrated with each other using the API, are configured to conduct real-time communication between the agent and the customer to resolve the request.

2. The system of claim 1 wherein the sign language is American Sign Language (“ASL”).

3. The system of claim 1 wherein the agent is in a financial center, a store, a contact center, or a call center.

4. The system of claim 1 wherein the brick-and-mortar location is a financial center, and the AI virtual assistant is a virtual financial assistant (“VFA”).

5. The system of claim 1 wherein the VR headset comprises VR, augmented reality (“AR”), extended reality (“XR”), spatial computing, or a combination herein.

6. The system of claim 1 wherein the system for improved service to the customer leads to an improved level of customer satisfaction.

7. The system of claim 1 wherein the real-time communication between the agent and the customer comprises:
sign language, from the customer, that is translated by the VR headset worn by the customer into text that is transmitted using the AI virtual assistant to the agent as text or as speech; and
typed text, from the agent, that is transmitted by the AI virtual assistant to the VR headset, worn by the customer, as sign language or text.

8. The system of claim 1 wherein the real-time communication between the agent and the customer comprises:
sign language, from the customer, that is translated by the VR headset worn by the customer into text that is transmitted using the AI virtual assistant to the agent as text or as speech, said VR headset being a first VR headset; and
speech, spoken by the agent, that is translated by a second VR headset worn by the agent into text and transmitted to the customer on the VR headset as sign language or text.

9. The system of claim 1 wherein the agent does not know sign language.

10. A method for improving service to a customer who is hearing impaired, the method comprising:
translating, using a virtual reality (“VR”) headset, a request for assistance from sign language into text, said request is made by the customer using sign language, and said customer is wearing the VR headset at a brick-and-mortar location of an organization;
transmitting, using the VR headset, the text of the request to an artificial intelligence (“AI”) virtual assistant, said AI virtual assistant is integrated with the VR headset using an application programming interface (“API”);
confirming, using the AI virtual assistant, with the customer that the AI virtual assistant has a correct understanding of the request;
determining, using the AI virtual assistant, a team in the organization that can assist the customer;
transferring, using the AI virtual assistant, the customer to an agent in the team; and
conducting, using the AI virtual assistant integrated with the VR headset, a real-time communication between the agent and the customer to resolve the request.

11. The method of claim 10 wherein the sign language is American Sign Language (“ASL”).

12. The method of claim 10 wherein the agent is in a financial center, a store, a contact center, or a call center.

13. The method of claim 10 wherein the brick-and-mortar location is a financial center, and the AI virtual assistant is a virtual financial assistant (“VFA”).

14. The method of claim 10 wherein the VR headset comprises VR, augmented reality (“AR”), extended reality (“XR”), spatial computing, or a combination herein.

15. The method of claim 10 wherein the method for improving service to the customer leads to an improved level of customer satisfaction.

16. The method of claim 10 wherein the real-time communication between the agent and the customer comprises:
sign language, from the customer, that is translated by the VR headset worn by the customer into text that is transmitted using the AI virtual assistant to the agent as text or as speech; and
typed text, from the agent, that is transmitted by the AI virtual assistant to the VR headset, worn by the customer, as text or translated by the VR headset into sign language.

17. The method of claim 10 wherein the real-time communication between the agent and the customer comprises:
sign language, from the customer, that is translated by the VR headset worn by the customer into text that is transmitted using the AI virtual assistant to the agent as text or as speech, said VR headset being a first VR headset; and
speech, spoken by the agent, that is translated by a second VR headset worn by the agent into text and transmitted to the customer on the VR headset as sign language or text.

18. The method of claim 10 wherein the agent does not know sign language.

19. A method for improving service to a customer who is hearing impaired, the method comprising:
translating, using a virtual reality (“VR”) headset, a request for assistance from sign language into text, said request is made by the customer using sign language, and said customer is wearing the VR headset at a brick-and-mortar location of an organization;
transmitting, using the VR headset, the text of the request to an artificial intelligence (“AI”) virtual assistant, said AI virtual assistant is integrated with the VR headset using an application programming interface (“API”);
confirming, using the AI virtual assistant, with the customer that the AI virtual assistant has a correct understanding of the request;
determining, using the AI virtual assistant, a team in the organization that can assist the customer;
transferring, using the AI virtual assistant, the customer to an agent in the team; and
conducting, using the AI virtual assistant integrated with the VR headset, a real-time communication between the agent and the customer to resolve the request;
wherein:
the agent does not know sign language;
the real-time communication between the agent and the customer comprises:
a customer communication, said customer communication comprising sign language from the customer that is:
translated by the VR headset worn by the customer into text;
transmitted as text by the AI virtual assistant to the agent; and
presented as text or speech to the agent; and
an agent communication, said agent communication comprising text or speech from the agent that is:
transmitted by the AI virtual assistant as text to the VR headset worn by the customer; and
presented as sign language or text to the customer; and
the request is resolved as a result of the real-time communication between the agent and the customer.

20. The method of claim 19 wherein:
the agent is located in a contact center;
the VR headset comprises VR, augmented reality (“AR”), extended reality (“XR”), spatial computing, or a combination herein;
the sign language is American Sign Language (“ASL”);
the brick-and-mortar location is a financial center; and
the AI virtual assistant is a virtual financial assistant (“VFA”).
